(19) United States
(12) Patent Application Publication
(10) Pub. No.: US 2017/0045912 A1
(43) Pub. Date: Feb. 16, 2017

(54) ELECTRONIC DEVICE

(71) Applicant: PEGATRON CORPORATION, TAIPEI CITY (TW)

(72) Inventors: Chih-Cheng HSU, TAIPEI (TW); Kuo-Jung HSU, TAIPEI (TW)

(21) Appl. No.: 15/173,727

(22) Filed: Jun. 6, 2016

(30) Foreign Application Priority Data
Aug. 12, 2015 (TW) 104126285

(51) Int. Cl. G06F 1/16

(52) U.S. Cl. CPC G06F 1/1616; G06F 1/1637; G06F 1/1681

(57) ABSTRACT

An electronic device comprises a first electronic component and a second electronic component. The first and second electronic components are pivoted and electrically connected to each other. A first substrate and a second substrate of the second electronic component are opposite to each other. The switch is positioned between the first substrate and the elastic member which is in movable to contact with or be away from the switch. When the first electronic component is rotated to a side of the first substrate, the magnetic member attracts the elastic member so that the elastic member is moved toward the first substrate and contacts the switch. When the first electronic component is rotated to a side of the second substrate, the magnetic member attracts the elastic member so that the elastic member is moved toward the second substrate and is disposed away from the switch.

This application claims priority to Taiwanese Application Serial Number 104126285, filed on Aug. 12, 2015, which is herein incorporated by reference.

### BACKGROUND

Technology Field

The present invention relates to devices. More particularly, the present invention relates to an electronic device.

Description of Related Art

A conventional laptop has a Hall effect magnetic sensing element for sensing changes in magnetic force, so as to determine whether its screen is flipped in open or closed status. In some approaches, the laptop supports a tablet mode that the screen is rotated at an angle of 360 degrees. No matter whether the screen is closed at an angle of 0 degrees or the screen is rotated at the angle of 360 degrees in the tablet mode, the Hall effect magnetic sensing element is affected by the same magnetic force. In other words, the Hall effect magnetic sensing element cannot distinguish the 0 degrees from the 360 degrees, and thus, the laptop may erroneously turn off the screen in the tablet mode. In order to avoid erroneously turning off the screen in the tablet mode, the laptop uses a metal sheet as a magnetic barrier to be against the magnetic force.

However, the metal sheet cannot isolate the magnetic force completely because of tolerances of the magnet and space limitation. As a result, a portion of the magnetic force still passes through the metal sheet.

### BRIEF SUMMARY

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one aspect, the present disclosure provides an electronic device that can determines whether an angle between two electronic components is 0 or 360 degrees.

According to embodiments of the present disclosure, the electronic device includes a first electronic component and a second electronic component. The first electronic component and the second electronic component are pivoted and electrically connected to each other. The first electronic component has a magnetic member, and the second electronic component has a first substrate, a second substrate, an elastic member and a switch. The first substrate and the second substrate are opposite to each other. The switch is positioned between the first substrate and elastic member. The elastic member is in movable to contact with or be away from the switch. When the first electronic component is rotated to a side of the first substrate of the second electronic component, the magnetic member attracts the elastic member so that the elastic member is moved toward the first substrate and contacts the switch. When the first electronic component is rotated to a side of the second substrate of the second electronic component, the magnetic member attracts the elastic member so that the elastic member is moved toward the second substrate and is disposed away from the switch.

According to embodiments of the present disclosure, the elastic member is a magnetic metal piece, and the magnetic member is a magnet. When the magnetic metal piece is attracted by a magnetic force of the magnet, the magnetic metal piece is in movable to contact with or be away from the switch.

According to embodiments of the present disclosure, the second electronic component has a fastening member disposed therein. The fastening member fastens one end of the elastic member, and another end of the elastic member has a protrusion portion oriented toward the switch.

According to embodiments of the present disclosure, the electronic device further includes a dual-hinge mechanism. The dual-hinge mechanism has a first pivot and a second pivot, wherein the first pivot is connected to the second pivot, the first pivot is pivoted to the first electronic component, and the second pivot is pivoted to the second electronic component.

According to embodiments of the present disclosure, the first electronic component is a screen, the second electronic component is a host, the switch is a printed circuit board (PCB) having a contact point, and the PCB is disposed in the host.

According to embodiments of the present disclosure, the first substrate has an input device, and the second substrate is a back plane of the host.

According to embodiments of the present disclosure, the host comprises a control unit, and the control unit is electrically connected to the screen and the PCB. When the elastic member contacts the contact point of the PCB, the control unit sends a disable signal to the screen, so that the screen is turned off.

According to embodiments of the present disclosure, the first substrate is a back plane of the host, and the second substrate has an input device.

According to embodiments of the present disclosure, the host comprises a control unit, and the control unit electrically connected to the screen and the PCB, wherein when the elastic member and the contact point of the PCB are disconnected from each other, the control unit sends a disable signal to the screen, so that the screen is turned off.

According to embodiments of the present disclosure, the first electronic component is a host, and the second electronic component is a screen.

In view of the foregoing, the present disclosure replaces the conventional Hall effect magnetic sensing element with the elastic member. The elastic member generates elastic deformation when attracted by the magnetic member as well as having characteristic of resilience.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a side view drawing of an electronic device according to a first embodiment of the present disclosure;

FIG. 2 is a side view drawing of the electronic device in one status according to the first embodiment of the present disclosure;

FIG. 3 is a side view drawing of the electronic device in another status according to the first embodiment of the present disclosure;

FIG. 4 is a pictorial drawing of the electronic device according to the first embodiment of the present disclosure;

FIG. 5 is a partial block diagram of the electronic device according to the first embodiment of the present disclosure;

FIG. 6 is a side view drawing of the electronic device in one status according to the second embodiment of the present disclosure;

FIG. 7 is a side view drawing of the electronic device in another status according to the second embodiment of the present disclosure;

FIG. 8 is a side view drawing of the electronic device in yet another status according to the second embodiment of the present disclosure;

FIG. 9 is a pictorial drawing of the electronic device according to the second embodiment of the present disclosure; and

FIG. 10 is a partial block diagram of the electronic device according to the second embodiment of the present disclosure.

### DETAILED DESCRIPTION

In the following detailed description, for purposes of explanation, numerous specific details are set forth in order to attain a thorough understanding of the disclosed embodiments. In accordance with common practice, like reference numerals and designations in the various drawings are used to indicate like elements/parts. Moreover, well-known elements or method steps are schematically shown or omitted in order to simplify the drawing and to avoid unnecessary limitation to the claimed invention.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

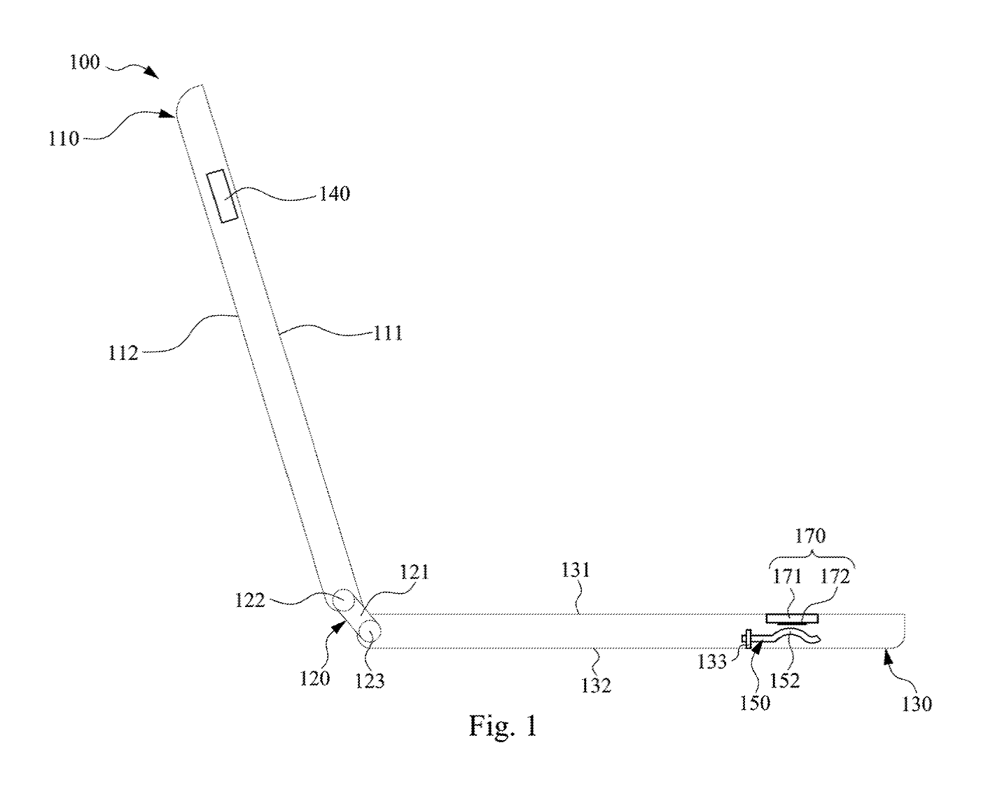

In one aspect, the present disclosure is directed to an electronic device. The screen of the electronic device can be flipped in 360-degree rotations. The electronic device may be a laptop, a handheld game console, a translator device or other electronic products, but not limited thereto. The implementation of the present electronic device is described below in connection with FIG. 1 to FIG. 10.

FIG. 1 is a side view drawing of an electronic device 100 according to a first embodiment of the present disclosure. As illustrated in FIG. 1, the electronic device 100 includes a first electronic component 110 and a second electronic component 130. The first electronic component 110 is pivoted to and electrically connected to the second electronic component 130, so that the first electronic component 110 can be rotated with respect to the second electronic component 130, and signals can be transmitted between the first electronic component 110 and the second electronic component 130.

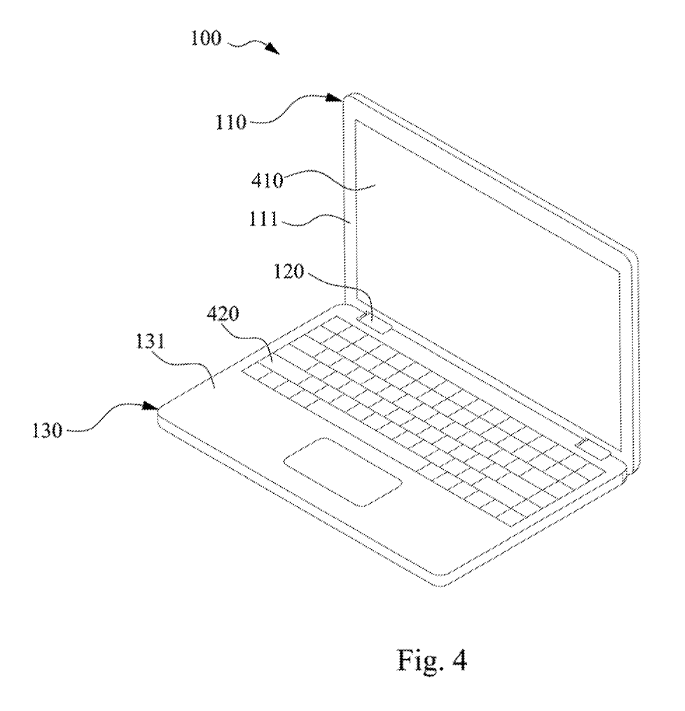

For example, the first electronic component 110 is a screen, and the second electronic component 130 is a host. The first surface 111 of the first electronic component 110 has a display panel 410 as shown in FIG. 4, and the second surface 112 of the first electronic component 110 is an outer casing of the screen. The first substrate 131 of the second electronic component 130 has an input device 420 as shown in FIG. 4, and the second substrate 132 of the second electronic component 130 is a back plane of the host. The first substrate 131 and the second substrate 132 are opposite to each other and may be respective upper and lower housing structures of the host.

The first electronic component 110 has a magnetic member 140, and the second electronic component 130 has an elastic member 150 and a switch 170. The elastic member 150 and the switch 170 approximate to each other and are positioned between the first substrate 131 and the second substrate 132. The elastic member 150 is positioned between the switch 170 and the second substrate 132 and is in movable to contact with or be away from the switch 170.

As illustrated in FIG. 1, an included angle between the first electronic component 110 and the second electronic component 130 is approximately ranged between 90 degrees and 180 degrees. The magnetic member 140 is disposed away from the elastic member 150, and therefore the magnetic member 140 cannot attract the elastic member 150. Moreover, the elastic member 150 is pulled down by gravity, so that the elastic member 150 cannot physically contact the switch 170. In this status, the second electronic component 130 (e.g., the host) allows the first electronic component 110 (e.g., the screen) to be turned on.

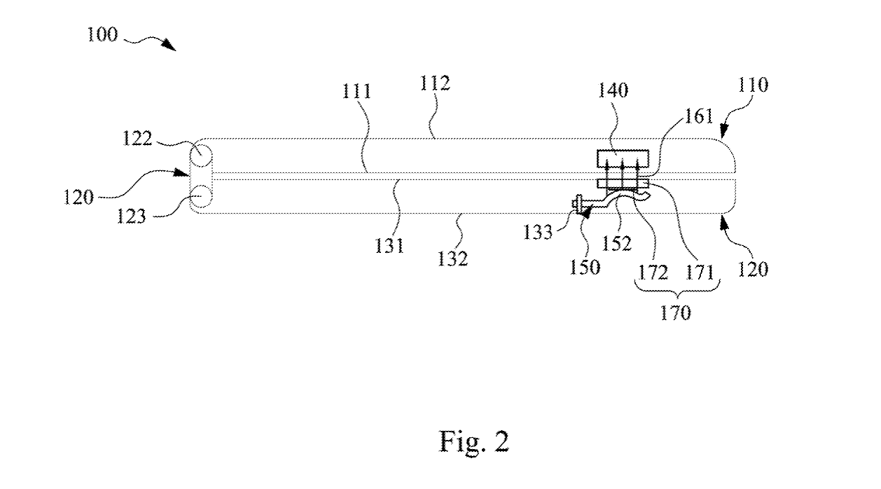

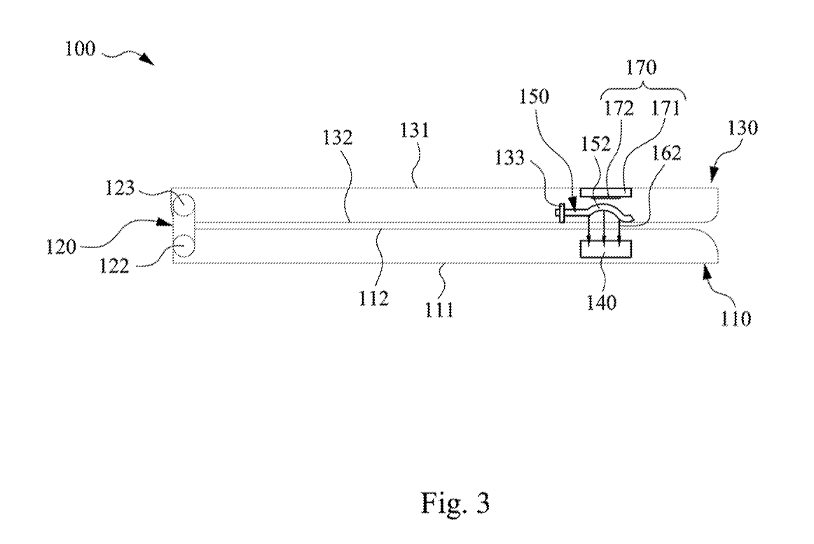

In FIG. 1, the electronic device 100 includes a dual-hinge mechanism 120. The dual-hinge mechanism 120 has a first pivot 122 and a second pivot 123, and the first pivot 122 is disposed adjacent to the second pivot 123. Specifically the first pivot 122 and the second pivot 123 are connected through a connecting part 121, where the first pivot 122 is pivoted to the first electronic component 110, and the second pivot 123 is pivoted to the second electronic component 130. Thus, the first electronic component 110 can be rotated to the first substrate 131 of the second electronic component 130, as shown in FIG. 2. Alternatively, the first electronic component 110 can be rotated to the second substrate 132 of the second electronic component 130, as shown in FIG. 3.

When the user make first electronic component 110 and the second electronic component 130 of the electronic device 100 be in the closed status as shown in FIG. 2, the first electronic component 110 is rotated to a side of the first substrate 131 of the second electronic component 130. Since the first surface 111 of the first electronic component 110 is close to the side of the first substrate 131 of the second electronic component 130, the magnetic member 140 attracts the elastic member 150, so that the elastic member 150 is moved toward the first substrate 131 and contacts the switch 170. Thus, the second electronic component 130 (e.g., the host) turns off the first electronic component 110 (e.g., the screen), and the display function of the first electronic component 110 is disabled. The state of the host can be changed from a usage state into a sleep state.

In some embodiments, after the host is shut down, while the first and second electronic components 110 and 130 of the electronic device 100 are in the closed status so that the elastic member 150 contacts the switch 170, and the host is not allowed to be powered on; therefore, the screen is still turned off, and its display function is disabled. Thus, the electronic device 100 is prevented from being turned on by malfunction.

In FIG. 2, the magnetic member 140 may be a magnet, and the elastic member 150 may be a magnetic metal piece. When the magnetic metal piece is attracted by the magnetic force 161 of the magnet, the magnetic metal piece movably contacts the switch 170. The switch 170 may include a printed circuit board (PCB) 171 having a contact point 172 (e.g., a conductive pad), and the PCB 171 is disposed in the host. When the magnetic metal piece is attracted by the magnetic force 161 to contact the contact point 172 of the PCB 171, the electrical state of the PCB 171 is changed, and thus, the host can operate in the sleep state or still be shut down.

In FIG. 2, the second electronic component 130 has the fastening member 133 disposed therein, where the fastening member 133 is connected to the second substrate 132, the fastening member 133 fastens one end of the elastic member 150, and another end of the elastic member 150 has the protrusion portion 152. The protrusion portion 152 is oriented toward the switch 170, so as to improve the opportunity of for the elastic member 150 to contact the switch 170 while the magnetic force 161 attracts the elastic member 150, thereby avoiding the problem that the elastic member 150 cannot actually connect the switch 170, in which this problem results from production tolerances and space limitations on the elastic member 150. It should be noted that FIG. 2 illustrates the protrusion portion 152 as a bent portion with radians for illustrative purposes only, and the present disclosure is not limited thereto. In various embodiments, the protrusion portion 152 of the elastic member 150 may be shaped as a bump or another suitable protrusion.

In some cases, the user flips the first electronic component 110 with respect to the second electronic component 130 in 360-degree rotations, so that the electronic device 100 can be set in the tablet mode. As shown in FIG. 3, the first electronic component 110 is rotated to a side of the second substrate 132 of the second electronic component 130. Since the second surface 112 of the first electronic component 110 is close to the side of the second substrate 132 of the second electronic component 130, the magnetic member 140 attracts the elastic member 150, so that the elastic member 150 is moved toward the second substrate 132 and disposed away from the switch 170. Thus, the second electronic component 130 (e.g., the host) turns on the first electronic component 110 (e.g., the screen), and the display function of the first electronic component 110 is enabled. The state of the host can be changed from the sleep state into the usage state.

In FIG. 3, the magnetic member 140 may be a magnet, and the elastic member 150 may be a magnetic metal piece. When the magnetic metal piece is attracted by the magnetic force 162 of the magnet, the magnetic metal piece is movably disposed away from the switch 170.

In some embodiments, after the host is shut down, while the first electronic component 110 is flipped with respect to the second electronic component 130 in 360-degree rotations, so that the elastic member 150 cannot contact the switch 170, and the host is allowed to be powered on; then, the screen is turned on, and its display function is enabled. Thus, the electronic device 100 can operate in the tablet mode.

FIG. 4 is a pictorial drawing of the electronic device 100 according to the first embodiment of the present disclosure. As illustrated in FIG. 4, the electronic device may be a laptop, a handheld game console, a translator device or other electronic products. The first electronic component 110 is the screen, and its first surface 111 has the display panel 410. The second electronic component 130 is the host, and its first substrate 131 has the input device 420 (e.g., a keyboard).

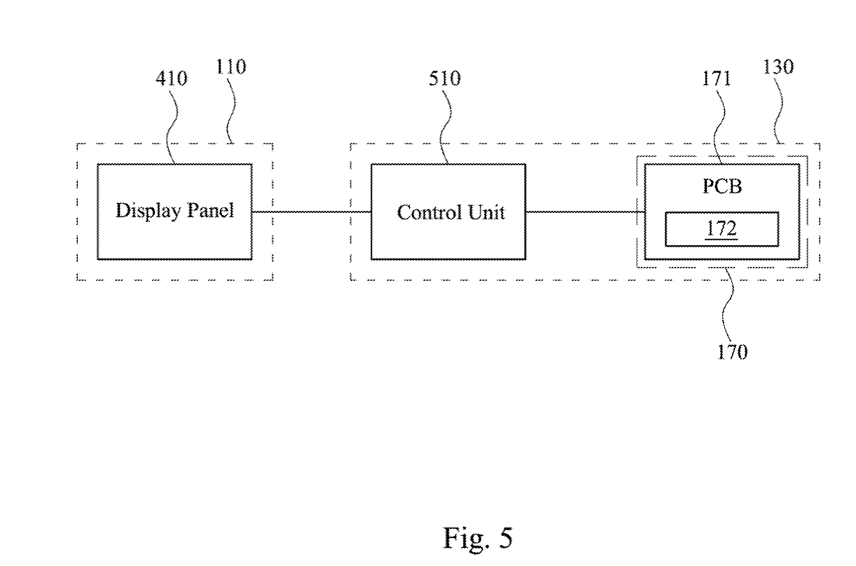

FIG. 5 is a partial block diagram of the electronic device according to the first embodiment of the present disclosure. As illustrated in FIG. 5, the second electronic component 130 (e.g., the host) includes a control unit 510. The control unit 510 is electrically connected to the first electronic component 110 (e.g., the screen) and the PCB 171. In practice, the control unit 510 is mounted on the motherboard and is connected to the PCB 171 through a flexible circuit board or other conductive lines. For example, the control unit 510 is a micro control unit (MCU), a baseboard management controller, a processor or the like.

When the elastic member 150 (shown in FIG. 2) contacts the contact point 172 of the PCB 171, the control unit 510 sends a disable signal to the screen, so that the screen can be turned off, and the display panel 410 of the screen does not display images. When the elastic member 150 (shown in FIG. 3) and the contact point 172 of the PCB 171 are disconnected from each other, the control unit 510 sends an enable signal to the screen, so that the screen can be turned on, and the display panel 410 of the screen can display the images. For example, the display panel 410 may be a touch display panel, so that the user can easily use gestures on the touch display panel in the tablet mode.

It should be noted that in the first embodiment the first electronic component 110 is the screen, and the second electronic component 130 is the host, but the present disclosure is not limited thereto. In various embodiments, the first electronic component 110 may be the host, and the second electronic component 130 may be the screen. Those with ordinary skill in the art may flexibly design these components depending on the desired application.

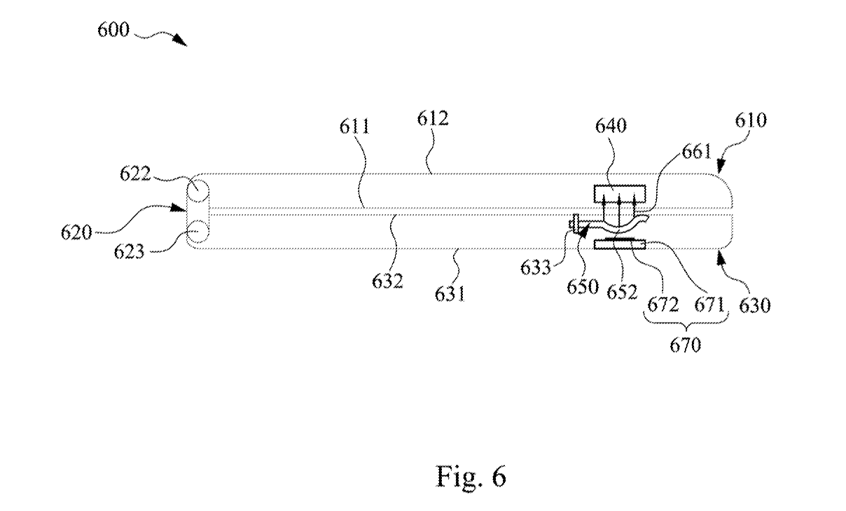

FIG. 6 is a side view drawing of the electronic device 600 in one status according to the second embodiment of the present disclosure. The electronic device 600 is structurally similar to the electronic device 100 except that the arrangements of a fastening member 633, an elastic member 650 and a switch 670 are changed.

As illustrated in FIG. 6, the electronic device 600 includes a first electronic component 610 and a second electronic component 630. The first electronic component 610 is pivoted to and electrically connected to the second electronic component 630, so that the first electronic component 610 can be rotated with respect to the second electronic component 630, and signals can be transmitted between the first electronic component 610 and the second electronic component 630.

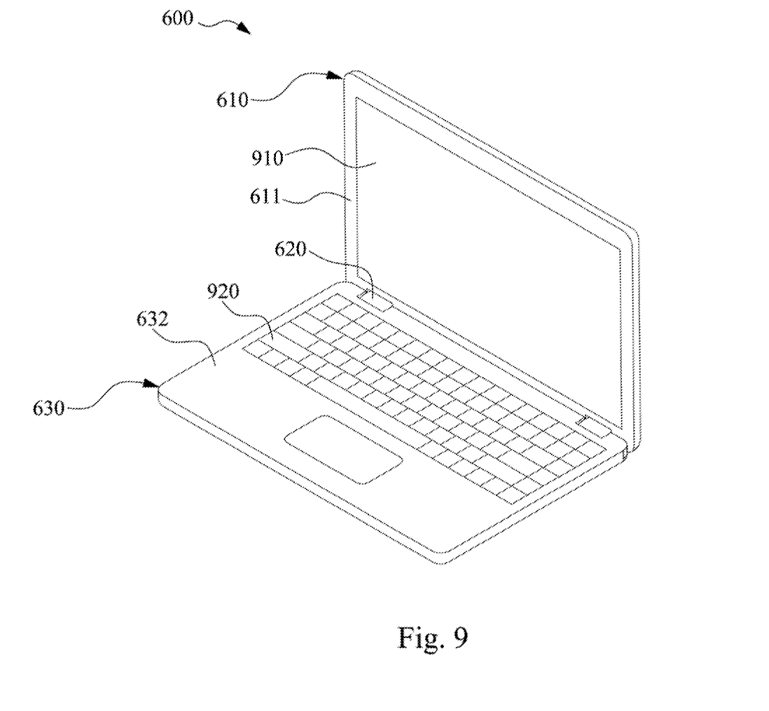

For example, the first electronic component 610 is a screen, and the second electronic component 630 is a host. The first surface 611 of the first electronic component 610 has a display panel 910 as shown in FIG. 9, and the second surface 612 of the first electronic component 610 is an outer casing of the screen. The second substrate 632 of the second electronic component 630 has an input device 920 as shown in FIG. 9, and the first substrate 631 of the second electronic component 630 is a back plane of the host. The switch 670 is positioned between the first substrate 631 and the elastic member 650, and the elastic member 650 is movably positioned between the switch 670 and the second substrate 632. The second substrate 632 and the first substrate 631 are opposite to each other and may be respective upper and lower housing structures of the host.

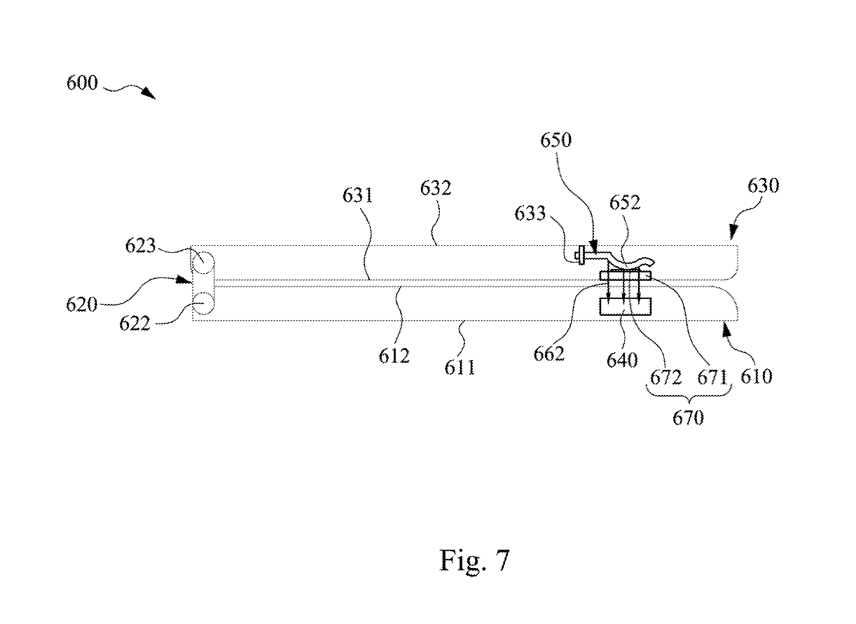

In FIG. 6, the electronic device 600 includes a dual-hinge mechanism 620. The dual-hinge mechanism 620 has a first pivot 622 and a second pivot 623, and the first pivot 122 is disposed adjacent to the second pivot 123. Specifically the first pivot 622 and the second pivot 623 are connected through a connecting part 621, where the first pivot 622 is pivoted to the first electronic component 610, and the second pivot 623 is pivoted to the second electronic component 630. Thus, the first electronic component 610 can be rotated to the first substrate 631 of the second electronic component 630, as shown in FIG. 7. Alternatively, the first electronic component 610 can be rotated to the second substrate 632 of the second electronic component 630, as shown in FIG. 6.

When the user make first electronic component 610 and the second electronic component 630 of the electronic device 600 be in the closed status as shown in FIG. 6, the first electronic component 610 is rotated to a side of the second substrate 632 of the second electronic component 630. Since the first surface 611 of the first electronic component 610 is close to the side of the second substrate 632 of the second electronic component 630, the magnetic member 640 attracts the elastic member 650, so that the elastic member 640 is moved toward the second substrate 632 and disposed away from the switch 670. Thus, the second electronic component 630 (e.g., the host) turns off the first electronic component 610 (e.g., the screen), and the display function of the first electronic component 610 is disabled. The host can be can operate in the sleep state or still be shut down.

In FIG. 6, the magnetic member 640 may be a magnet, and the elastic member 650 may be a magnetic metal piece. When the magnetic metal piece is attracted by the magnetic force 661 of the magnet, the magnetic metal piece is movably disposed away from the switch 670. Therefore, the protrusion portion 652 of the magnetic metal piece cannot contact the contact point 672 of the PCB 671.

In some cases, the user flips the first electronic component 610 with respect to the second electronic component 630 in 360-degree rotations, so that the electronic device 600 can be set in the tablet mode. As shown in FIG. 7, the first electronic component 610 is rotated to a side of the first substrate 631 of the second electronic component 630. Since the second surface 612 of the first electronic component 110 is close to the side of the first substrate 631 of the second electronic component 130, the magnetic member 640 attracts the elastic member 650, so that the elastic member 650 is moved toward the first substrate 631 and contacts the switch 670. Thus, the second electronic component 630 (e.g., the host) turns on the first electronic component 610 (e.g., the screen), and the display function of the first electronic component 610 is enabled.

In FIG. 7, the magnetic member 640 may be a magnet, and the elastic member 650 may be a magnetic metal piece. When the magnetic metal piece is attracted by the magnetic force 662 of the magnet, the magnetic metal piece movably contacts the switch 670. Specifically, the protrusion portion 652 of the magnetic metal piece is in direct to contact with the contact point 672 of the PCB 671. so that the electrical state of the PCB 171 can be changed. Thus, the host allows the screen to be turned on, and the display function of the screen is enabled.

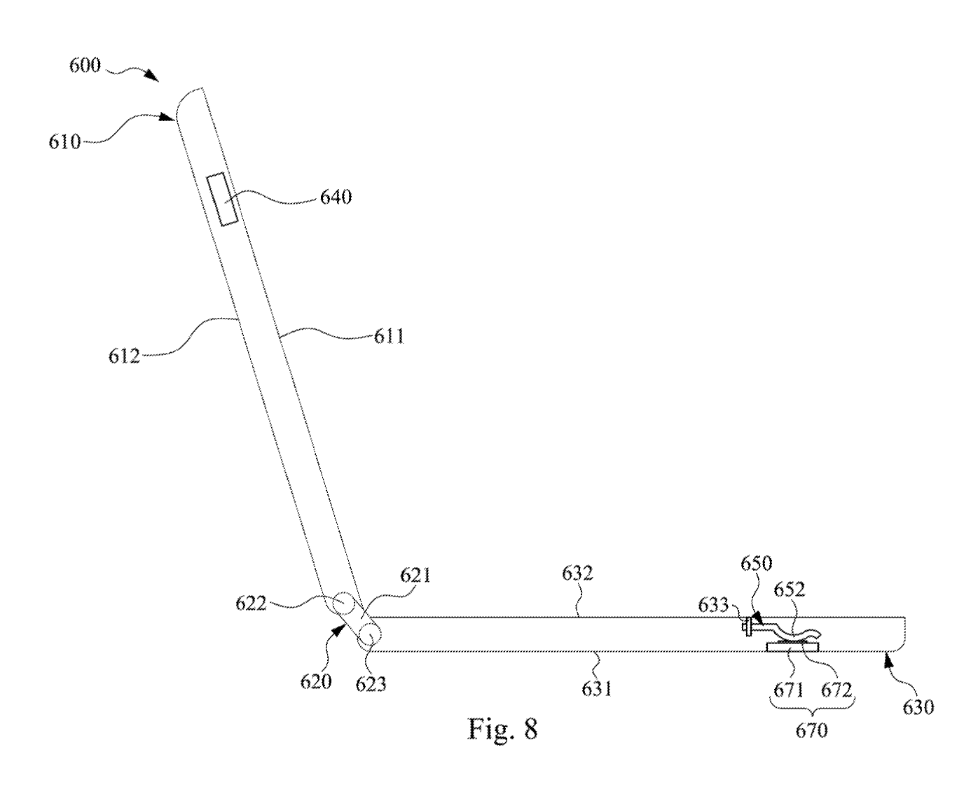

As illustrated in FIG. 8, when the user flips the screen of the electronic device 600 in a normal notebook mode, an included angle between the first electronic component 610 and the second electronic component 630 is approximately ranged between 90 degrees and 180 degrees. The magnetic member 640 is disposed away from the elastic member 650, and therefore the magnetic member 140 cannot attract the elastic member 150. Moreover, the elastic member 650 is pulled down by gravity, so that the elastic member 650 can physically contact the switch 670. In this status, the second electronic component 630 (e.g., the host) allows the first electronic component 610 (e.g., the screen) to be turned on, and the display function of the screen is enabled.

FIG. 9 is a pictorial drawing of the electronic device 600 according to the second embodiment of the present disclosure. As illustrated in FIG. 9, the electronic device 600 may be a laptop, a handheld game console, a translator device or other electronic products. The first electronic component 610 is the screen, and its first surface 611 has the display panel 910. The second electronic component 630 is the host, and its second substrate 632 has the input device 920 (e.g., a keyboard).

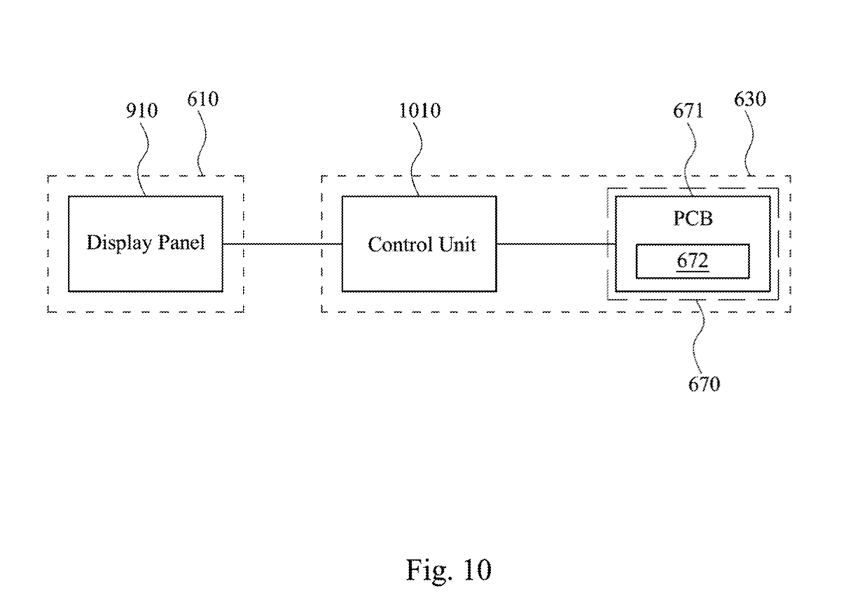

FIG. 10 is a partial block diagram of the electronic device 600 according to the second embodiment of the present disclosure. As illustrated in FIG. 10, the second electronic component 630 (e.g., the host) includes a control unit 1010. The control unit 1010 is electrically connected to the first electronic component 1610 (e.g., the screen) and the PCB 671. In practice, the control unit 1010 is mounted on the motherboard and is connected to the PCB 671 through a flexible circuit board or other conductive lines.

When the elastic member 650 (shown in FIG. 6) and the contact point 672 of the PCB 671 are disconnected from each other, the control unit 1010 sends a disable signal to the screen, so that the screen can be turned off, and the display panel 910 of the screen does not display images. When the elastic member 650 (shown in FIGS. 7 and 8) contacts the contact point 172 of the PCB 171, the control unit 1010 sends an enable signal to the screen, so that the screen can be turned on, and the display panel 410 of the screen can display the images.

It should be noted that in the second embodiment the first electronic component 610 is the screen, the second electronic component 630 is the host, but the present disclosure is not limited thereto. In various embodiments, the first electronic component 610 may be the host, and the second electronic component 630 may be the screen. Those with ordinary skill in the art may flexibly design these components depending on the desired application.

In view of the above, the present disclosure replaces the conventional Hall effect magnetic sensing element with the elastic member. The elastic member generates elastic deformation when attracted by the magnetic member as well as having characteristic of resilience.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany claims.

What is claimed is:

1. An electronic device, comprising:
a first electronic component having a magnetic member; and
a second electronic component pivoted and electrically connected to the first electronic component, wherein the second electronic component has a first substrate, a second substrate, an elastic member and a switch, the first substrate and the second substrate are opposite to each other, the switch is positioned between the first substrate and the elastic member, and the elastic member is in movable to contact with or be away from the switch,
when the first electronic component is rotated to a side of the first substrate of the second electronic component, the magnetic member attracts the elastic member, so that the elastic member is moved toward the first substrate and contacts the switch,
when the first electronic component is rotated to a side of the second substrate of the second electronic component, the magnetic member attracts the elastic member, so that the elastic member is moved toward the second substrate and is disposed away from the switch.

2. The electronic device of claim 1, wherein the elastic member is a magnetic metal piece, and the magnetic member is a magnet, wherein when the magnetic metal piece is attracted by a magnetic force of the magnet, the magnetic metal piece is in movable to contact with or be away from the switch.

3. The electronic device of claim 1, wherein the second electronic component has a fastening member disposed therein, the fastening member fastens one end of the elastic member, and another end of the elastic member has a protrusion portion oriented toward the switch.

4. The electronic device of claim 1, further comprising:
a dual-hinge mechanism having a first pivot and a second pivot, wherein the first pivot is connected to the second pivot, the first pivot is pivoted to the first electronic component, and the second pivot is pivoted to the second electronic component.

5. The electronic device of claim 1, wherein the first electronic component is a screen, the second electronic component is a host, the switch is a printed circuit board (PCB) having a contact point, and the PCB is disposed in the host.

6. The electronic device of claim 5, wherein the first substrate has an input device, and the second substrate is a back plane of the host.

7. The electronic device of claim 6, wherein the host comprises a control unit, and the control unit is electrically connected to the screen and the PCB, wherein when the elastic member contacts the contact point of the PCB, the control unit sends a disable signal to the screen, so that the screen is turned off.

8. The electronic device of claim 5, wherein the first substrate is a back plane of the host, and the second substrate has an input device.

9. The electronic device of claim 8, wherein the host comprises a control unit, and the control unit electrically connected to the screen and the PCB, wherein when the elastic member and the contact point of the PCB are disconnected from each other, the control unit sends a disable signal to the screen, so that the screen is turned off.

10. The electronic device of claim 1, wherein the first electronic component is a host, and the second electronic component is a screen.
